(19) United States
(12) Patent Application Publication
(10) Pub. No.: US 2024/0171004 A1
(43) Pub. Date: May 23, 2024

(54) COMPRESSED AIR ENERGY STORAGE

(71) Applicant: J. Ray McDermott, S.A., Houston, TX (US)

(72) Inventor: Jos VAN REISEN, The Hague (NL)

(21) Appl. No.: 18/513,068

(22) Filed: Nov. 17, 2023

Related U.S. Application Data
(60) Provisional application No. 63/426,237, filed on Nov. 17, 2022.

(51) Int. Cl. H02J 15/00

(52) U.S. Cl. CPC H02J 15/006; F02C 6/16

(57) ABSTRACT

A system includes an air compression train, a compressed air storage, an air expansion train, a heat management subsystem, and a power transmission subsystem. The heat management subsystem is configured to receive a heated heat transfer fluid flow and to provide a low-temperature heat transfer fluid flow to the air compression train from a low-temperature heat transfer fluid storage vessel. The heat management subsystem is coupled to the air expansion train and is configured to receive a cooled heat transfer fluid flow and to provide a high-temperature heat transfer fluid flow to the air expansion train from a high-temperature heat transfer fluid storage vessel. The heat management system is configured such that a first heat source is coupled to the high-temperature heat transfer fluid storage vessel.

### CROSS-REFERENCE TO RELATED PATENT APPLICATIONS

This Application claims the benefit of and priority to U.S. Provisional Patent Application No. 63/426,237, filed on Nov. 17, 2022, and titled “Compressed Air Energy Storage Configuration Concept”, the contents of which are incorporated by reference in their entirety.

### BACKGROUND

### Field

This disclosure is related to the fields of power generation and energy storage. More specifically, this disclosure is related to methods and processes for utilizing compressible fluids to store and generate energy.

### Description of the Related Art

Compressed Air Energy Storage (CAES) is a type of facility that takes advantage of a first period of power source surplus (for example, inexpensive fuel sources, grid power excess) or availability (for example, sunlight, robust winds, heavy waves, strong water currents) with a second period of power shortage (for example, expensive fuel sources, a dearth of grid power) or unavailability (for example, nighttime, calm winds and water currents). A CAES facility utilizes surplus power during the first period to compress air and store the compressed air in a closed volume. For practical compression, the air should be cooled before each stage of compression. During the second period the CAES facility generates power from the stored compressed air by expanding the compressed air over a turbine that drives a power generator. The stored air is normally at close to ambient temperature. For efficient expansion of the stored, the compressed air should be heated prior to each stage of expansion.

There are two well-appreciated CAES process. One known concept is a diabatic CAES (D-CAES), which utilizes an external heat source to supply heat to the air that is expanded, producing power.

There is also an adiabatic CAES (A-CAES), which utilizes heat generated from the one or more air compressors, stores the heat in a heat retention medium, and utilizes the heated heat retention medium during a second period for air expansion.

### SUMMARY

A system includes an air compression train. The air compression train is configured to receive an atmospheric air feed flow and a first amount power and to produce a cooled, compressed air. The system includes a compressed air storage. The compressed air storage is coupled to the air compression train. The compressed air storage is configured to receive the cooled, compressed air, to maintain the cooled, compressed air as a stored, compressed air for an indefinite period, and to produce the stored, compressed air. The system includes an air expansion train that is coupled to the compressed air storage. The air expansion train is configured to receive the stored, compressed air and to produce an exhausted, decompressed air flow and a second amount of power. The first amount of power is greater than or equal to the second amount of power. The system includes a heat management subsystem that is coupled to the air compression train. The heat management subsystem is configured to receive a heated heat transfer fluid flow from the air compression train and to provide a low-temperature heat transfer fluid flow to the air compression train from a low-temperature heat transfer fluid storage vessel. The heat management subsystem is coupled to the air expansion train and is configured to receive a cooled heat transfer fluid flow from the air expansion train and to provide a high-temperature heat transfer fluid flow to the air expansion train from a high-temperature heat transfer fluid storage vessel. The heat management system is configured such that the high-temperature heat transfer fluid storage vessel is positioned upstream of and coupled to the low-temperature heat transfer fluid storage vessel. The heat management system is configured such that a first heat source is coupled to the high-temperature heat transfer fluid storage vessel. The system includes a power transmission subsystem. The power transmission system is coupled to the air compression train, the heat management subsystem, and the air expansion train. The power transmission system is configured to provide power to the air compression train and the heat management subsystem and to receive power from the air expansion train. A first power coupling directed to the heat management subsystem couples to the first heat source.

### BRIEF DESCRIPTION OF THE DRAWINGS

So that the manner in which the recited features of the present disclosure may be understood in detail, a more particular description of the disclosure may be had by reference to one or more embodiments, some of which are illustrated in the appended drawings. It is to be noted, however, that the appended drawings illustrate only one or more of the several embodiments; therefore, the one or more embodiments provided in the Drawings are not to be considered limiting of the broadest interpretation of the detailed scope. Other effective embodiments as may be described in the Detailed Description may be considered part of the envisioned detailed scope.

FIG. 1 is a schematic representation of a prior art adiabatic compressed air energy storage (A-CAES) system.

FIG. 2 is a schematic representation of a first improved adiabatic compressed air energy storage (IA-CAES) system, according to one or more embodiments.

FIG. 3 is a schematic representation of a second improved adiabatic compressed air energy storage (IA-CAES) system, according to one or more embodiments.

FIG. 4 is a schematic representation of a third improved adiabatic compressed air energy storage (IA-CAES) system, according to one or more embodiments.

FIG. 5 is a schematic representation of a fourth improved adiabatic compressed air energy storage (IA-CAES) system, according to one or more embodiments.

FIG. 6 is a schematic representation of a fifth improved adiabatic compressed air energy storage (IA-CAES) system, according to one or more embodiments.

FIG. 7 is a schematic representation of a sixth improved adiabatic compressed air energy storage (IA-CAES) system, according to one or more embodiments.

In this disclosure, the terms “upstream” and “downstream” and the like do not refer to absolute directions; rather, these terms refer to positions relative to one unit or stream in comparison to another unit or stream, and indicate a direction of fluid flow. These non-specific positions may be vertical, horizontal, or other angular orientation in actual practice.

In this disclosure, the designation “'” may represent that a property or a state relating to a condition has been modified from a previous condition.

To facilitate understanding and better appreciation for the described scope, in some instances either identical or similar reference numerals have been used (where possible) to designate identical or similar elements, respectively, that are common in the various Drawings. One of skill in the art may appreciate that elements and features of one embodiment may be beneficially incorporated in one or more other embodiments without further recitation.

### DETAILED DESCRIPTION

In the following disclosure, reference may be made to one or more embodiments. However, one of skill in the art appreciates that the disclosure is not limited to any specifically described embodiment. Rather, any combination of features and elements, whether related to different embodiments or not, is contemplated to implement and practice the one or more embodiments provided by the disclosure. Furthermore, although the one or more embodiments presented in the disclosure may achieve certain advantages over other possible solutions, the prior art (if existing), and combinations thereof, whether or not a particular advantage is achieved by a given embodiment is not limited by this disclosure. The aspects, features, embodiments, and advantages provided are merely illustrative, and do not limit the scope of the disclosure. The aspects, features, embodiments, and advantages provided are not considered elements or limitations of the appended claims except where explicitly recited in one or more of the Claims. Likewise, one of skill in the art should not construe a reference to “the disclosure” as a generalization of any disclosed subject matter.

There are distinct implementation issues with a purely adiabatic CAES (A-CAES). A-CAES requires a sizable and efficient heat storage facility for the high-temperature heat transfer fluid. There are significant issues not only with the transfer large amounts of energy into and out the storage facility for ease of use but also the sheer size of the heat sink to retain the heat captured from the compression portion of the system, especially at near or at atmospheric conditions, is challenging. The first industrial size applications of such a facility are still under development at this time.

In regards to a diabatic CAES (D-CAES), there is the use of fuels to provide the heat for the air expansion portion of the system. Often, these heat sources use a fired heater or gas turbine, which causes carbon dioxide (CO2) emissions, which defeats the strong potential for these types of compressed air systems to help prevent and eliminate CO2 emissions. As an alternative, hydrogen (H2) firing may also be considered; however, hydrogen is difficult to manage, especially when it is not in a cryogenic state. To maintain hydrogen in a cryogenic state requires additional power and facilities. As well, there is always a question about the source of hydrogen, especially if the hydrogen originates or is processed along with other hydrocarbons, again defeating the environmental potential of such CAES systems.

Aspects of the present disclosure relate to one or more embodiment improved adiabatic compressed air energy storage (IA-CAES) systems. Each IA-CAES is a hybrid configuration where each embodiment system may perform in an adiabatic operation for a first period and a diabatic operation for the second period. The first period adiabatic operation limits the required heat storage capacity. Configuration are adiabatic when power is used that is generated by expansion air stored in the system air storage. The second period diabatic operation continues power generation when the heat storage is exhausted. Configuration are diabatic when power from outside the system is used, like electrical power from the grid at a relatively reduced cost. This is contrary to standard D-CAES systems, no hydrocarbon-based fuel is used in any mode of operation. The heat input for the diabatic operation is generated from power using a heat source, such as an electrical heater or a heat transfer device, such as a heat pump. The first and second periods may overlap in certain instances based upon system configuration, operation, or both.

Embodiment systems may be described as having three different modes of operation. An air charge mode provides both compressed air and heat for storage using available power from the grid. This is mainly performed by the air compression train in support with the heat management subsystem, to be described. Air is taken from the atmosphere and pressurized by a multi-stage compressor with interstage cooling to a storage pressure using power from the grid. The pressurized air is routed to a storage facility, for example, a natural or artificial cavern. Interstage coolers (a.k.a. intercoolers) use a heat transfer fluid at a relatively low temperature to cool the air before compression. After compression, the intercoolers recover the generated heat of compression and make heated heat transfer fluid for later use, such as during a discharge mode, to be described forthcoming. The generated heat is stored in one or more heat transfer fluid storage vessels, and any excess heat that cannot be stored is rejected to atmosphere. The systems associated with the air charge mode may have a plurality of parallel trains for operational flexibility.

When the heat transfer fluid storage capacity is less than what is feasible to store all the recoverable heat generated by the air compression train to reach full air storage capacity, heat rejection into the atmosphere may be used to release the excess heat. This situation may occur when a subsurface air storage facility is used—there simply may not be sufficient natural or artificial heat transfer fluid reservoir(s) to safely and efficiently retain all the heat generated for later use.

A second mode of operation includes a heat charge mode. The heat charge mode is where the heat storage vessels, such as the low-, medium-, and high-temperature heat transfer fluid storage vessels, to be described further, are used to either or both store heat in a heat transfer fluid or use stored heat transfer fluid or power to upgrade the quality of the stored heat. Such upgrading of stored heat transfer fluid may utilize available power from the grid to power heat sources, such as heat transfer devices, such as one or more heat pumps, or an electrical heater. Heat is stored in the heat transfer fluid at a relative high temperature that is suitable for introduction into the preheaters for the air expansion train while in discharge mode. In one or more embodiments, which may be combined with other embodiments, the system may be operated such that the air charge mode overlaps with the heat charge mode.

A heat pumps extracts heat from a heat transfer fluid at a relatively low temperature level, such as from the environment, a low-temperature heat transfer fluid, or an medium-temperature heat transfer fluid, and transfers the extracted heat into a second fluid, generally using a compressor, such that the second fluid has an improved quality (that is, a relatively higher temperature) and is passed from the heat pump.

The power for the heat source may originate from a variety of systems, including external power grid or an internal power grid based upon additional recovery of energy, such as from excess heat or additional pressure drop from compressed fluids, and converted into power for such use. For example, a heat pump may be driven either by power imported from an external grid or by power generated from the expansion of compressed air from the compressed air storage during the discharge mode. As well, a dedicated expander driver on the heat pump may also be used. Such power generation systems are beyond the scope of this application except where directly associated with embodiment systems, including power generation from the air expansion train.

If the relatively hot heat transfer fluid in a heat storage vessel or one of the relatively intermediate temperature heat storages is not fully filled or the quality of the heat transfer fluid is degrading (that is, the temperature is being reduced), the quality of the heat transfer fluid may be improved during the heat charge mode. In some embodiment systems, heat may also be stored a one or more intermediate temperature (that is, a temperature greater than a relatively low temperature, such as ambient temperatures, and less than a relatively high temperature, such as a temperature associated with preheating compressed air being discharged during discharge mode) in a heat transfer fluid storage vessel designed to retain heat transfer fluid at an intermediary temperature.

The third mode of operation includes an air discharge mode. Stored, high pressure air is directed from the air storage system that has been filled during the air charge mode to the air expansion train. Preheaters utilize heated heat transfer fluid from the heat management subsystem to heat the air before expansion. In passing through an air expander, the temperature of the partially-decompressed air is reduced to a temperature that is at or greater than ambient conditions. Each preheater transfers heat into the decompressing air before passing through another expander until a final expansion occurs into the atmosphere at atmospheric pressure and ambient temperature. The cooled heating medium from the preheater is recovered and stored in relatively low temperature storage. Preheating may be done in a single exchanger using the relatively hot heat transfer fluid or by a series of exchangers.

In one or more embodiments, which may be combined with other embodiments, the system may be operated such that the air discharge mode overlaps with the heat charge mode. Discharge mode may have simultaneous production of the heat required for expansion in case the heat transfer fluid in the relatively hot heat transfer storage tank is exhausted or not available. The size of a heat source, such as an electric heater or a heat pump, should be configured to produce or extract the heat to generate the hot heat transfer fluid at the relatively high temperature.

A greater storage of heat in the form of a higher temperature may be used to preheat air during the discharge mode to increases the power output per amount of air expanded; power generation potential is a sum of air stored at relative higher pressure (that is, greater than ambient conditions), with higher pressure gives greater power generation potential. Heat stored at relatively high temperature heat transfer fluid at higher temperature give greater power generation potential during air expansion.

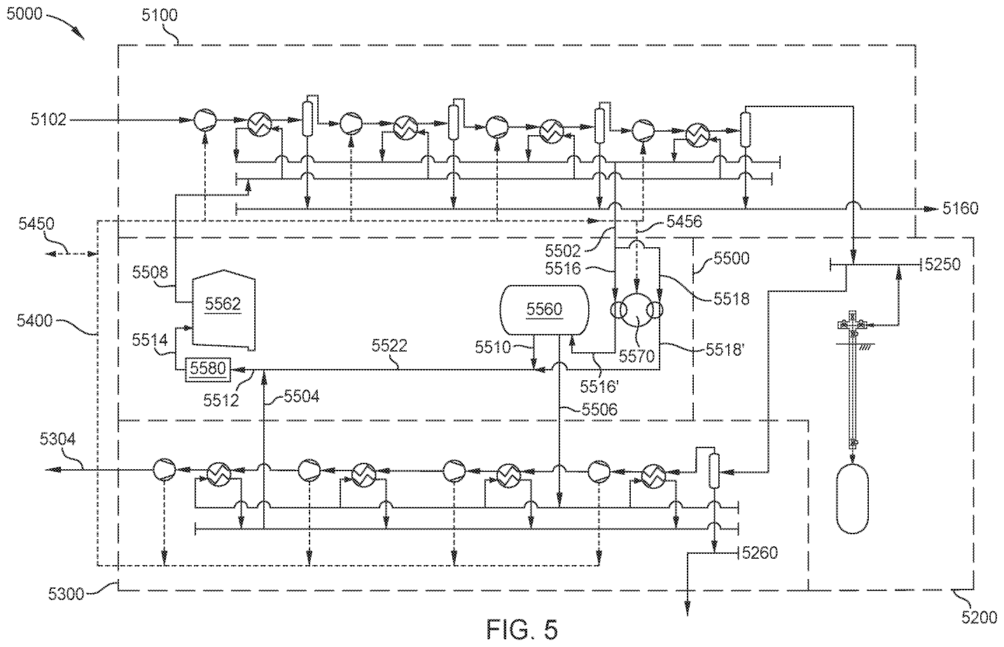

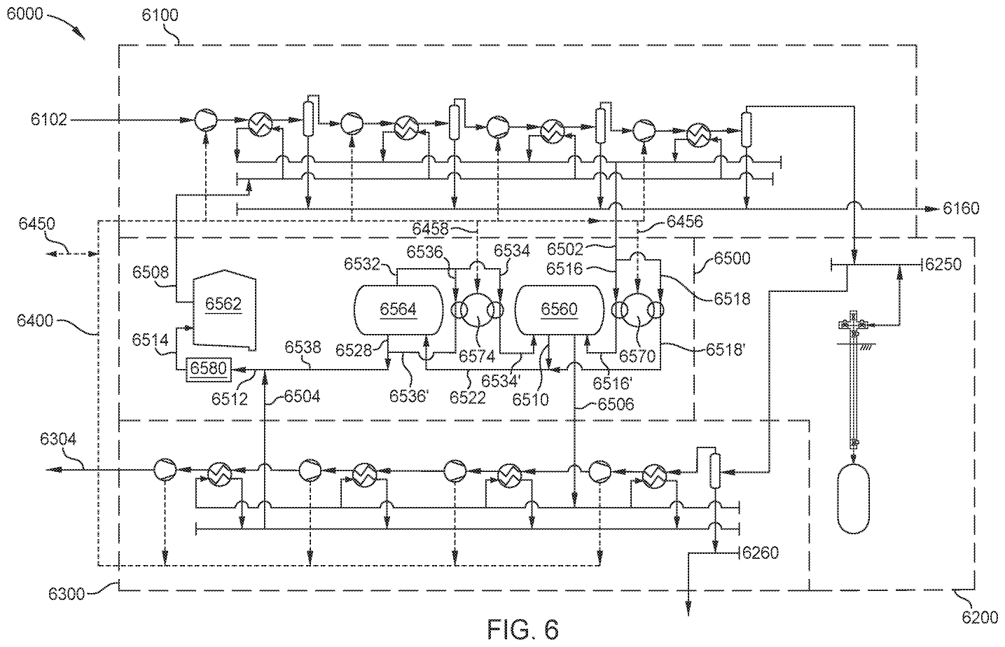

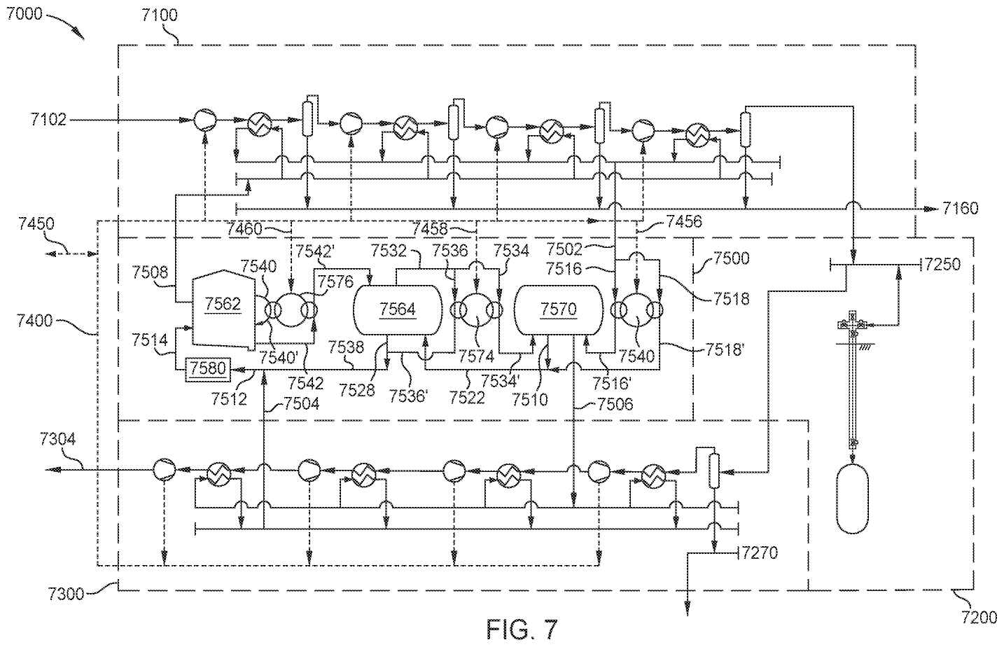

Embodiment of the systems may be implemented in stages. For example, a more efficient embodiment system, such as system 7000 of FIG. 7, to be described further, may be of a configuration that results from expansion of a prior embodiment system, such as system 6000 of FIG. 6 or system 5000 of FIG. 5, each to be described further.

One of the benefits of the embodiment systems is that given the power source for compression, it is feasible that the embodiment systems are not associated with any discharge or production of carbon dioxide (CO2). If the power generation uses renewable or sustainable power production resources, one may find that the entire operation is either net carbon neutral or even negative. In one or more embodiments, which may be combined with other embodiments, the system is configured such that there are no carbon dioxide (CO2) emissions from the operation of the system.

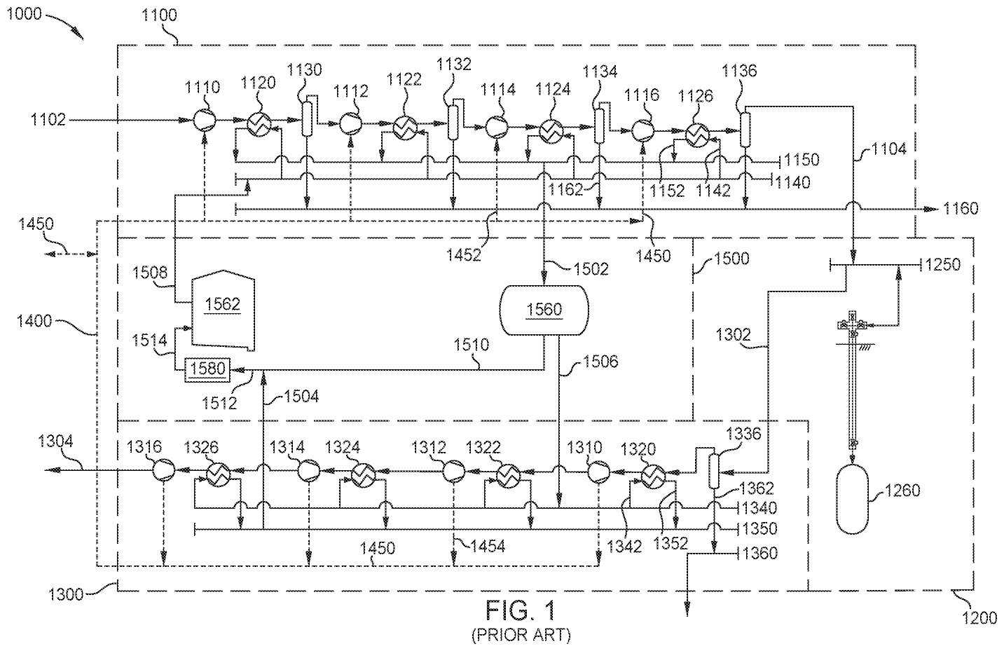

FIG. 1 is a schematic representation of a prior art adiabatic compressed air energy storage (A-CAES) system. System 1000 includes several subsystems coupled with one another, including air compression train 1100, compressed air storage 1200, air expansion train 1300, power transmission subsystem 1400, and heat management subsystem 1500.

System 1000 has several fluid and power import and export conduits. Air feed conduit 1102 introduces air at atmospheric conditions into an upstream portion of the air compression train 1100. Air exhaust conduit 1304 discharges previously compressed air into the atmosphere from a downstream portion of the air expansion train 1300. There are condensed water headers 1160, 1360, respectively, that collect and discharge knocked out water from the air compression train 1100 and the front of the air expansion train 1300, respectively. There is also power conduit 1450 that couples to an exterior power resource (not shown). The power conduit 1450 is configured such that the power conduit 1450 may both convey power into the system 1000 during a period of air compression and storage charge and out from the system 1000 during a period of compressed air discharge and power generation.

As provided in FIG. 1, air compression train 1100 is shown having a series of air compressors 1110, 1112, 1114, and 1116, coupled together in series along a compressed air header 1104. The first or lead air compressor 1110 receives the introduced air from air feed conduit 1102. Coupled downstream of each air compressor 1110, 1112, 1114, and 1116, along the compressed air header 1104 is an intercooler 1120, 1122, 1124, and 1126, respectively, to remove heat from the hot, compressed air discharged from each respective air compressor 1110, 1112, 1114, and 1116, forming cooled, compressed air. Coupled downstream of each intercooler 1120, 1122, 1124, and 1126, along the compressed air header 1104 is a knock-out pot 1130, 1132, 1134, and 1136, respectively, to remove condensed liquid water from the cooled, compressed air, forming cooled, compressed air. From the last or trailing knock out pot 1136, the cooled, compressed air passes out of the air compression train 1100 and is directed towards the compressed air storage 1200 using the compressed air header 1104.

There are additional couplings to each unit in air compression train 1100. Each air compressor 1110, 1112, 1114, and 1116, is shown in FIG. 1 coupled to the common power conduit 1450 using power supply extension 1452 such that each air compressor 1110, 1112, 1114, and 1116, receives power. Each intercooler 1120, 1122, 1124, and 1126, is shown coupled downstream of the cool heat transfer fluid header 1140 (using feed line 1142) and coupled upstream of the heated heat transfer fluid return header 1150 (using return line 1152). Each intercooler 1120, 1122, 1124, and 1126, is configured to receive cooling heat transfer fluid from the cool heat transfer fluid header 1140, transfer heat from the hot, compressed air into the introduced cooling heat transfer fluid such that a heated medium forms, and pass the heated heat transfer fluid to the heated heat transfer fluid return header 1150. The cool heat transfer fluid header 1140 and the heated heat transfer fluid return header 1150 are fluidly coupled to units in the heat management subsystem 1500, which will be described in more detail forthcoming. Each knock out pot 1130, 1132, 1134, and 1136, is shown coupled to the condensed water header 1160, which passes condensed water out of the air compression train 1100 and the system 1000, using the drain line 1162.

Compressed air header 1104 introduces the cooled, compressed air from air compression train 1100 into compressed air storage 1200. Compressed air header 1104 is fluidly coupled to air storage header 1250, which is configured to receive cooled, compressed air during a period of air compression and storage charge. FIG. 1 provides a compressed air storage facility 1260, such as an underground cavern, fluidly coupled with air storage header 1250 such that the cooled, compressed air may be introduced into the compressed air storage facility 1260 and maintained there for an indefinite period as stored, compressed air.

As provided in FIG. 1, air storage header 1250 is also coupled to compressed air intake conduit 1302, which passes the stored, compressed air from compressed air storage 1200 into air expansion train 1300 during a period of compressed air discharge and power generation.

Air expansion train 1300 in FIG. 1 has a series of air expanders 1310, 1312, 1314, and 1316, coupled together in series along the air exhaust conduit 1304. Coupled upstream of each air expander 1310, 1312, 1314, and 1316, along the air exhaust conduit 1304 is a preheater 1320, 1322, 1324, and 1326, respectively, that provides heat into the air feed before each respective air expander 1310, 1312, 1314, and 1316. Coupled upstream of the first or lead air expander 1310 along the air exhaust conduit 1304 is a knock out drum 1336 to prevent any entrained liquid water that may originate from the compressed air storage 1200 from entering the first or lead air expander 1310. From the last or trailing air expander 1316, the exhausted, decompressed air passes out of the air expansion train 1300 and from the system 1000 through air exhaust conduit 1304.

There are additional couplings to each unit in air expansion train 1300. Each air expander 1310, 1312, 1314, and 1316, is shown in FIG. 1 coupled to the common power conduit 1450 using power return extension 1454 such that each air expander 1310, 1312, 1314, and 1316, may introduce generated power into the power transmission subsystem 1400 from expansion of the compressed air. Each preheater 1320, 1322, 1324, and 1326, is shown coupled downstream of the heated heat transfer fluid header 1340 (using feed line 1342) and coupled upstream of the cool heat transfer fluid return header 1350 (using return line 1352). Each preheater 1320, 1322, 1324, and 1326, is configured to receive heating heat transfer fluid from the heated heat transfer fluid header 1340, transfer heat to the cold, compressed air prior to expansion such that a cool heat transfer fluid forms, and pass the cool heat transfer fluid to the cool heat transfer fluid return header 1350. The heated heat transfer fluid header 1340 and the cool heat transfer fluid return header 1350 are fluidly coupled to units in the heat management subsystem 1500, which will be described in more detail forthcoming. The knock out pot 1336 is coupled to the condensed water header 1360, which passes condensed water out of the air expansion train 1300 and the system 1000, using the drain line 1362.

System 1000 as shown in FIG. 1 includes heat management subsystem 1500. In an A-CAES system, the heat generated by the air compression train 1100 in increasing the pressure and temperature while decreasing the volume of air is extracted from the air compression train 1100 to improve the overall efficiency of compressing the air at each compression stage. Some of the recovered heat is then applied to the compressed air at each stage of expansion as the compressed air decompresses through air expansion train 1300. A heat transfer fluid is transferred around the heat management subsystem 1500 such that a relative cooler heat transfer fluid is provided to the air compression train 1100 and a hotter heat transfer fluid is provided to the air expansion train 1300.

Heat management subsystem 1500 is shown in FIG. 1 comprising a high-temperature heat transfer fluid storage vessel 1560 and a low-temperature heat transfer fluid storage vessel 1562. The two vessels 1560, 1562 are fluidly coupled to one another through the cool heat transfer fluid header 1140 and the hot heat transfer fluid return header 1150 of the air compression train 1100 via the intercoolers 1120, 1122, 1124, and 1126. Cooling heat transfer fluid feed line 1508 introduces heat transfer fluid from the low-temperature fluid heat transfer fluid storage vessel 1562 to the cool heat transfer fluid header 1140, and hot return line 1502 introduces heat transfer fluid to the high-temperature heat transfer fluid storage vessel 1560.

The two vessels 1560, 1562 of the heat management subsystem 1500 are also fluidly coupled to one another through the heated heat transfer fluid header 1340 and the cool heat transfer fluid return header 1350 of the air expansion train 1300 via the preheaters 1320, 1322, 1324, and 1326. Hot heat transfer fluid feed line 1506 introduces heat transfer fluid from the high-temperature heat transfer fluid storage vessel 1560 to the heated heat transfer fluid header 1340, and cool return line 1504 directs heat transfer fluid towards the low-temperature heat transfer fluid storage vessel 1562.

The two vessels 1560, 1562 of the heat management subsystem 1500 are also fluidly coupled to one another through heat management subsystem 1500 internal flow conduits. Hot heat transfer fluid reject line 1510 originates at the high-temperature heat transfer fluid storage vessel 1560 and passes an amount of hot heat transfer fluid towards the low-temperature heat transfer fluid storage vessel 1562. The heat transfer fluid in hot heat transfer fluid reject line 1510 and the heat transfer fluid in cool return line 1504 combine to form an excess heat exchanger inlet line 1512, which is introduced into excess heat exchanger 1580. Excess heat exchanger 1580, which in FIG. 1 is shown in a cooling fan configuration, transfers heat from the introduced heat transfer fluid on the tube side into the ambient air pulled through the exchanger on the fan side. Excess heat passes into the atmosphere and is rejected. The heat transfer fluid passing from the excess heat exchanger 1580 is introduced into the low-temperature heat transfer fluid storage vessel 1562 via introduction line 1514.

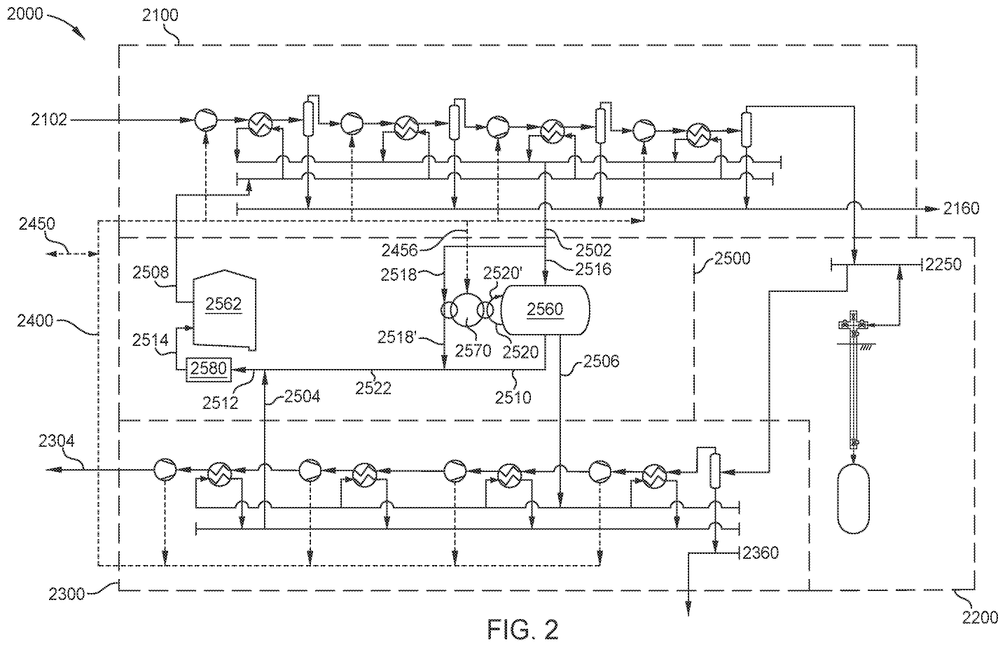

FIG. 2 is a schematic representation of an embodiment improved adiabatic compressed air energy storage (IA-CAES) system. Embodiment system 2000 has several configuration differences with system 1000 of FIG. 1.

In one or more embodiments, which may be combined with other embodiments, a system comprises an air compression train configured to receive an atmospheric air feed flow and to produce a cooled, compressed air flow and a first amount of power. The system also comprises a compressed air storage coupled to the air compression train and configured to receive the cooled, compressed air flow; maintain the cooled, compressed air as a stored, compressed air for an indefinite period; and produce the stored, compressed air. The system also comprises an air expansion train coupled to the compressed air storage and configured to receive the stored, compressed air flow and produce an exhausted, decompressed air flow and a second amount of power. The system also comprises a heat management subsystem that is coupled to the air compression train and configured to receive a heated heat transfer fluid flow from and provide a low-temperature heat transfer fluid flow to the air compression train from a low-temperature heat transfer fluid storage vessel; that is coupled to the air expansion train and configured to receive a cooled heat transfer fluid flow from and provide a high-temperature heat transfer fluid flow to the air expansion train from a high-temperature heat transfer fluid storage vessel; that is configured such that the high-temperature heat transfer fluid storage vessel is positioned and coupled upstream of the low-temperature heat transfer fluid storage vessel; and that is configured such that a first heat source is thermally and fluidly coupled to the high-temperature heat transfer fluid storage vessel. The system also comprises a power transmission subsystem that is coupled to the air compression train, the heat management subsystem, and the air expansion train. The power transmission subsystem is configured to provide power to the air compression train and the heat management subsystem, and is also configured to receive power from the air expansion train. The power transmission subsystem has a first coupling to the first heat source in the heat management subsystem.

The power transmission subsystem may use one or more configurations to transmit power through, into, and out of the embodiment system. In one or more embodiments, which may be combined with other embodiments, the first amount of power is greater than or equal to the second amount of power. In one or more embodiments, which may be combined with other embodiments, the power transmission subsystem is configured to receive and provide power electrically. In one or more embodiments, which may be combined with other embodiments, the power transmission subsystem is configured to receive and provide power hydraulically. In one or more embodiments, which may be combined with other embodiments, the power transmission subsystem is configured to receive and provide power pneumatically. In one or more embodiments, which may be combined with other embodiments, the power transmission subsystem is configured to receive and provide power mechanically. In one or more embodiments, which may be combined with other embodiments, the power transmission subsystem is configured to receive and provide power as selected from the group comprising electrically, pneumatically, hydraulically, mechanically, and combinations thereof.

In FIG. 2, power transmission subsystem 2400 is shown with a first power supply extension 2456 directed into the heat management subsystem 2500. The first power supply extension 2456 couples to a first heat pump 2570, which is a heat source, to be described further.

The configuration of an embodiment heat management subsystem, such as heat management subsystem 2500, may include elements that permit not only recovery of heat from heat transfer fluid that in a prior art system would have been rejected and likely wasted into the environment but also introduce the recovered heat into an already high-temperature heat transfer fluid to further improve its quality (that is, increase its temperature). Improving the quality of the high-temperature heat transfer fluid over what may be obtained using a mere adiabatic system may further improve the efficiency of the air expansion train, thereby increasing specific power generation potential (that is, power that can be generated per unit of stored air) from the overall system.

The heat transfer fluid may be stable fluid, either gas or liquid, with sensible heat properties for the temperature used. Examples of potentially useful heat transfer fluids include, but are not limited to, water, especially boiler-feed quality water and water condensed from the atmosphere, ethylene glycol, mixtures of ethylene glycol and water, salt-water brines and brackish water, mineral oils, silicones, and synthetic oils, such as Therminol™ (Solutia, Inc.; St. Louis, Missouri) and Dowterm™ (The Dow Chemical Company; Midland, Michigan).

Alternatively, improving the quality of the high-temperature heat transfer fluid by boosting heat that may have been previously rejected may permit a relative smaller amount of high-temperature heat transfer fluid to be used to generate the same amount of power.

In one or more embodiments, which may be combined with other embodiments, the first heat source is directly coupled to the high-temperature heat transfer fluid storage vessel and indirectly coupled to the low-temperature heat transfer fluid storage vessel. “Directly coupled” indicates that the heat transfer apparatus is in an isolated fluid flow loop with the vessel. In this instance, the first heat source is thermally and fluidly directly coupled to the high-temperature heat transfer fluid storage vessel. As shown in FIG. 2, the heat management system 2500 of embodiment system 2000 includes a first heat source, such as a heat transfer apparatus, such as a first heat pump 2570, that is both thermally and fluidly directly coupled to the high-temperature heat transfer fluid storage vessel 2560. “Indirectly coupled” indicates that the heat transfer apparatus is not in an isolated fluid flow loop with the vessel. In this instance, the heat transfer apparatus is fluidly indirectly coupled to the low-temperature heat transfer fluid storage vessel; the heat transfer fluid flow where heat is extracted does not originate from the low-temperature heat transfer fluid storage vessel itself.

The first heat pump 2570 is a heat transfer apparatus that is configured to draw high-temperature heat transfer fluid directly from the high-temperature heat transfer fluid storage vessel 2560 through heat pump draw line 2520. The drawn heat transfer fluid passes into first heat pump 2570, where it receives a quantity of heat, thereby increasing its temperature. The improved quality heat transfer fluid is directly returned to the high-temperature heat transfer fluid storage vessel 2560 through heat pump output line 2520′, thereby improving the overall quality (that is, increasing the temperature) of the heat transfer fluid in the high-temperature heat transfer fluid storage vessel 2560.

In one or more embodiments, which may be combined with other embodiments, the heat management subsystem is configured such that the heat transfer fluid directed towards the heat management subsystem from the air compression train is bifurcated into a first portion and a second portion of heat transfer fluid flow. In one or more embodiments, which may be combined with other embodiments, both the first portion and the second portion of the heat transfer fluid flow directed towards the heat management subsystem from the air compression train are introduced into the first heat source. In one or more embodiments, which may be combined with other embodiments, the first portion of the heated heat transfer fluid flow from the air compression train is directed into the high-temperature heat transfer fluid storage vessel and the second portion of the heat transfer fluid directed towards the heat management subsystem from the air compression train is directed into the low-temperature heat transfer fluid storage vessel. In one or more embodiments, which may be combined with other embodiments, the first heat source is configured to extract heat from the second portion of heated heat transfer fluid flow from the air compression train and transfer the extracted heat directly into the high-temperature heat transfer fluid storage vessel. The heat transferred into the high-temperature heat transfer fluid storage vessel is obtained from a portion of heat transfer fluid that is directed to bypass around the high-temperature heat transfer fluid storage vessel. In FIG. 2, system 2000 has hot return line 2502 bifurcated upstream of the high-temperature heat transfer fluid storage vessel 2560 into a hot supply main line 2516, which couples to the high-temperature heat transfer fluid storage vessel 2560, and a hot return bypass line 2518, which couples to the inlet of the first heat pump 2570. Heat is extracted from the heat transfer fluid introduced through the hot return bypass line 2518 into the first heat pump 2570 and produces a reduced quality heat transfer fluid that passes from the first heat pump 2570. The heat exchanged fluid in the reduced temperature heat transfer fluid reject line 2518′ merges with heat transfer fluid passed through the hot heat transfer fluid reject line 1510 into the combined hot heat transfer fluid reject line 2522. After merging the combined hot heat transfer fluid reject line 2522 heat transfer fluid with the cool return line 2504 heat transfer fluid, the excess heat exchanger inlet line 2512 is introduced into the excess heat exchanger 2580, which is similar to the excess heat exchanger 1580 as previously described.

Although FIG. 2 shows air compression train 2100 having four sets of compressors, intercoolers, and knock out pots, an air compression train for an embodiment system may comprise any number of such sets to achieve the charge flow of compressed air at a desired storage pressure. In one or more embodiments, which may be combined with other embodiments, the air compressor train comprises a single set of a compressor, an intercooler, and a knock out pot fluidly coupled along a compressed air header. In one or more embodiments, which may be combined with other embodiments, the air compressor train comprises a plurality of sets of compressors, intercoolers, and knock out pots, fluidly coupled along a compressed air header.

Although not shown in FIG. 2, there may be embodiment system configuration variations that depend in part on the configuration of one or more separate air compression trains. In one or more embodiments, which may be combined with other embodiments, a system may comprise a plurality of separate air compression trains. In essence, the system may comprise parallel air compression trains that operate independently of one another, such as when a first compression train may operate and a second compression train does not. In one or more embodiments, which may be combined with other embodiments, each air compression train is coupled to a common compressed air storage, power transmission subsystem, and heat management subsystem. That is, the plurality of parallel compression trains provide compressed air to the same compressed air storage, receive power from the same power transmission subsystem, and are fluidly coupled to the same heat management system. In one or more embodiments, which may be combined with other embodiments, each air compression train is coupled to a non-shared portion of the system, where the non-shared portion of the system is selected from the group consisting of compressed air storage, power transmission subsystem, heat management subsystem, and combinations thereof. For example, a plurality of air compression trains may feed into a common compressed air storage, but for logistical or power production reasons the power transmission subsystem and heat management subsystem are separate for each air compression train and are not shared.

Although FIG. 2 shows air expansion train 2300 having four sets of expanders and preheaters, an air expansion train for an embodiment system may comprise any number of such sets to achieve the desired amount of power production from the letdown amount of the stored, compressed air. In one or more embodiments, which may be combined with other embodiments, the air expansion train comprises a single set of a preheater and an expander fluidly coupled along an air exhaust conduit. In one or more embodiments, which may be combined with other embodiments, the air expansion train comprises a plurality of sets of preheaters and expanders fluidly coupled along an air exhaust conduit.

In one or more embodiments, which may be combined with other embodiments, the system is configured such that the number of air compressors in the air compression train is different than the number of air expanders in the air expansion train.

Although not shown in FIG. 2, there may be embodiment system configuration variations that depend in part on the configuration of one or more separate air expansion trains. In one or more embodiments, which may be combined with other embodiments, a system may comprise a plurality of separate air expansion trains. In essence, the system may comprise parallel air expansion trains that operate independently of one another, such as when a first expansion train may operate and a second expansion train does not. In one or more embodiments, which may be combined with other embodiments, each air expansion train is coupled to a common compressed air storage, power transmission subsystem, and heat management subsystem. That is, the plurality of parallel expansion trains let down compressed air from the same compressed air storage, provide power to the same power transmission subsystem, and are fluidly coupled to the same heat management system. In one or more embodiments, which may be combined with other embodiments, each air expansion train is coupled to a non-shared portion of the system, where the non-shared portion of the system is selected from the group consisting of compressed air storage, power transmission subsystem, heat management subsystem, and combinations thereof. For example, a plurality of air expansion trains may draw compressed air from a common compressed air storage, but for logistical or power production reasons the power transmission subsystem and heat management subsystem are separate for each air expansion train and are not shared.

Although FIG. 2 shows compressed air storage 1200 having a single compressed air storage facility 1260, a compressed air storage for an embodiment system may comprise any number of such compressed air storage facilities fluidly coupled along a common air storage header. A configuration with a plurality of compressed air storage facilities may provide flexibility to the operator of such a system to operate the air compressor train for longer periods of favorable, sustainable power production periods (for example, wind, solar) to exploit a prolonged period of lower exterior power costs or in preparation for a forecasted acute event, such a storm or an event, which may disable other power suppliers. One or more of a plurality of compressed air storage facilities may be held at pressure and content as an “emergency reserve” to provide power generation capability during a period of an unexpected acute event, such as a disaster, when other power producers may be off-line or reduced capacity and power demand is significant. As well, multiple air storage facilities permit “cost averaging” in an attempt to match power production with market pricing. In one or more embodiments, which may be combined with other embodiments, the compressed air storage comprises a single compressed air storage facility. In one or more embodiments, which may be combined with other embodiments, the compressed air storage comprises a plurality of compressed air storage facilities fluidly coupled along a common air storage header.

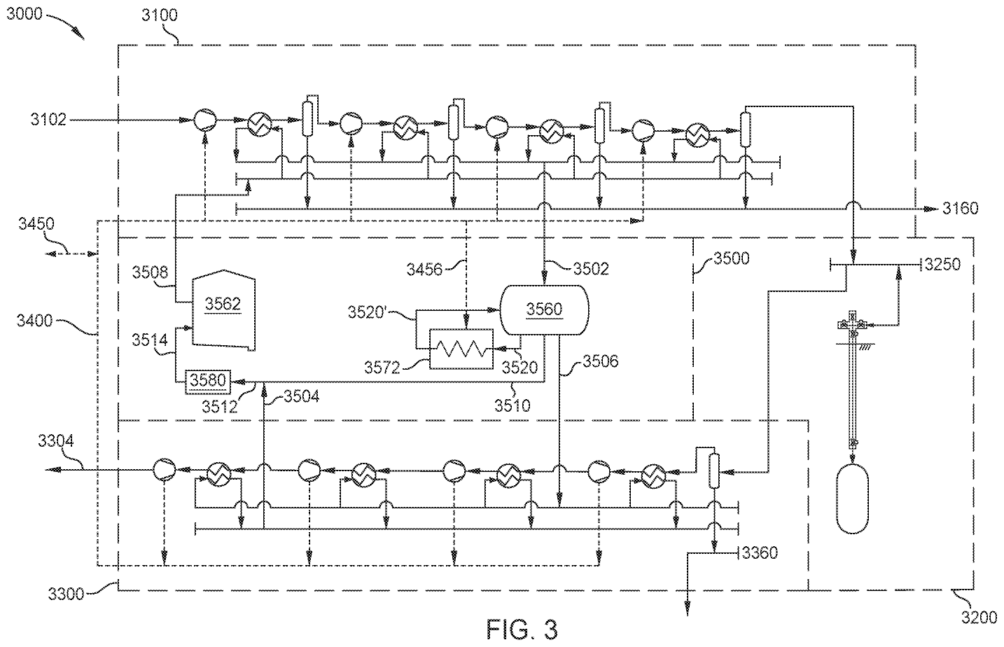

FIG. 3 is a schematic representation of an embodiment improved adiabatic compressed air energy storage (IA-CAES) system. Embodiment system 3000 has several configuration differences with system 1000 of FIG. 1, especially in the power transmission subsystem and the heat management subsystem.

In FIG. 3, power transmission subsystem 3400 is shown with a first power supply extension 3456 directed into the heat management subsystem 3500. The first power supply extension 3456 couples to an electrical heater 3572, which is a first heat source, to be described further.

In one or more embodiments, which may be combined with other embodiments, the first heat source is an electrical heater that is directly coupled to the high-temperature heat transfer fluid storage vessel. As shown in FIG. 3, the heat management system 3500 of embodiment system 3000 includes a heat source that is both thermally and fluidly directly coupled to the high-temperature heat transfer fluid storage vessel 3560. Electrical heater 3572 is configured to draw high-temperature heat transfer fluid from the high-temperature heat transfer fluid storage vessel 3560 through electrical heater draw line 3520. The to-be-improved heat transfer fluid passes into electrical heater 3572, where it receives a quantity of heat and its temperature increases. The now improved heat transfer fluid passes back into the high-temperature heat transfer fluid storage vessel 3560 through electrical heater output line 3520′, thereby improving the overall quality (that is, increasing the temperature) of the heat transfer fluid in the high-temperature heat transfer fluid storage vessel 3560.

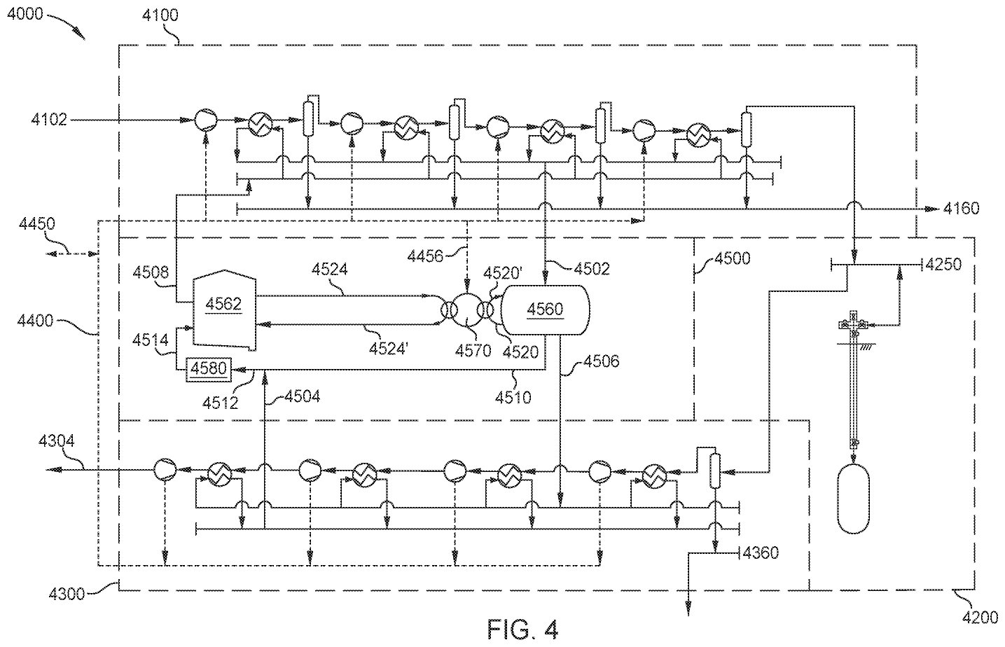

FIG. 4 is a schematic representation of an embodiment improved adiabatic compressed air energy storage (IA-CAES) system. Embodiment system 4000 has several configuration differences with system 1000 of FIG. 1, especially in the power transmission subsystem and the heat management subsystem.

In FIG. 4, power transmission subsystem 4400 is shown with a first power supply extension 4456 directed into the heat management subsystem 4500. The first power supply extension 4456 couples to a first heat pump 4570, which is a first heat source, to be described further.

As shown in FIG. 4, the heat management system 4500 of embodiment system 4000 includes a first heat source, such as a heat transfer apparatus, such as first heat pump 4570, that is thermally and fluidly directly coupled to the high-temperature heat transfer fluid storage vessel 4560. First heat pump 4570 and its relationship with the high-temperature heat transfer fluid storage vessel 4560 is similar in purpose and configuration to first heat pump 2570 as previously described and shown in FIG. 2.

In one or more embodiments, which may be combined with other embodiments, where the heat management system is configured such that the heat source is directly coupled to both the low-temperature heat transfer fluid storage vessel and the high-temperature heat transfer fluid storage vessel. In this instance, the first heat source is a heat transfer apparatus that is both thermally and fluidly directly coupled to the low-temperature heat transfer fluid storage vessel. First heat pump 4570 in embodiment system 4000 is also configured to draw low-temperature heat transfer fluid from the low-temperature heat transfer fluid storage vessel 4562 through heat pump draw line 4524. The drawn heat transfer fluid passes into first heat pump 4570, where it extracts a quantity of heat, thereby decreasing its temperature. The diminished quality heat transfer fluid is returned to the low-temperature heat transfer fluid storage vessel 4562 through heat pump output line 4524′, thereby decreasing the overall quality (that is, reducing the temperature) of the heat transfer fluid in the low-temperature heat transfer fluid storage vessel 4562.

FIG. 5 is a schematic representation of an embodiment improved adiabatic compressed air energy storage (IA-CAES) system. Embodiment system 5000 has several configuration differences with system 1000 of FIG. 1, especially in the power transmission subsystem and the heat management subsystem, which permits embodiment systems, such as system 5000, improve the quality of the heat exchange fluid in the high temperature heat exchange fluid storage vessel.

In FIG. 5, power transmission subsystem 5400 is shown with first power supply extension 5456 directed into the heat management subsystem 5500. First power supply extension 5456 couples to first heat pump 5570, which is a first heat source, to be described further.

In one or more embodiments, which may be combined with other embodiments, the heat management subsystem is configured such that the first heat source is indirectly coupled to both the high-temperature heat transfer fluid storage vessel and the low-temperature heat transfer fluid storage vessel.

As shown in FIG. 5, the heat management system 5500 of embodiment system 5000 includes a heat source, such as a is a heat transfer apparatus, such as first heat pump 5570, that is coupled both thermally and fluidly to the high-temperature heat transfer fluid storage vessel 5560; however, the coupling relationship is a one-way fluid flow relationship with the second heat pump—it is not in a direct flow loop.

In one or more embodiments, which may be combined with other embodiments, the heat management subsystem is configured such that both the first portion and the second portion of the heat transfer fluid flow directed towards the heat management subsystem from the air compression train are introduced into the first heat source, where the first heat source is configured to extract heat from the second portion of the heat transfer fluid flow and transfer the extracted heat into the first portion of the heat transfer fluid flow. In one or more embodiments, which may be combined with other embodiments, the heat management subsystem is configured such that the first portion of heat transfer fluid flow is directed into the high-temperature heat transfer fluid storage vessel and the second portion of the heat transfer fluid flow is directed towards the low-temperature heat transfer fluid storage vessel. As shown in FIG. 5, system 5000 has hot return line 5502 introduced from air compressor train 5100 into heat management subsystem 5500. Hot return line 5502 is then bifurcated upstream of the high-temperature heat transfer fluid storage vessel 5560 in a somewhat similar way as previously shown with system 2000 of FIG. 2. The bifurcated streams include a hot supply main line 5516, which is directed towards the high-temperature heat transfer fluid storage vessel 5560, and a hot return bypass line 5518, which is directed towards the low-temperature heat transfer fluid storage vessel 5562. The first heat pump 5570 is configured such that heat is transferred from the second portion of the heat transfer fluid in the hot return bypass line 5518, forming a reduced temperature heat transfer fluid in the reduced temperature heat transfer fluid reject line 5518′, and transferred into the first portion of the heat transfer fluid traversing the hot supply main line 5516, forming an improved heat transfer fluid in the improved hot supply main line 5516′. The improved heat transfer fluid is introduced into the high-temperature heat transfer fluid storage vessel 5560, thereby improving the quality of the heat transfer fluid stored. The reduced heat transfer fluid in the reduced temperature heat transfer fluid reject line 5518′ combines with heat transfer fluid passed from the high-temperature heat transfer fluid storage vessel 5560 through the hot heat transfer fluid reject line 5510, forming a combined rejected heat transfer fluid in the combined hot heat transfer fluid reject line 5522. Similar to as previously described, combined hot heat transfer fluid reject line 5522 heat transfer fluid with the cool return line 5504 heat transfer fluid, the heat transfer fluid in the excess heat exchanger inlet line 5512 are introduced into excess heat exchanger 5580.

In one or more embodiments, which may be combined with other embodiments, the heat management subsystem is operated such that the high-temperature heat transfer fluid storage vessel is maintained in a range of from about 170° C. to 190° C., such as about 175° C. and such as about 185° C.

In one or more embodiments, which may be combined with other embodiments, the heat management subsystem is operated such that the low-temperature heat transfer fluid storage vessel is maintained at a temperature in a range of from about 20 to 50° C., such as about 30° C.

In one or more embodiments, which may be combined with other embodiments, the heat management subsystem is operated such that the medium-temperature heat transfer fluid storage vessel is maintained at a temperature in between that of the low-temperature heat transfer fluid storage vessel and the of the high-temperature heat transfer fluid storage vessel, such as in a range of greater than about 20° C. and less than 190° C., such as in a range of from greater than about 20° C., 25° C., 30° C., 35° C., 40° C., 45° C., and about 50° C. to about 55° C., 60° C., 65° C., 70° C., 75° C., 80° C., 90° C., 95° C., 100° C., 105° C., 110° C., 115° C., 120° C., 125° C., 130° C., 135° C., 140° C., 145° C., 150° ° C., 155° C., 160° C., 165° C., 170° C., 175° C., 180° C., 185° C., and less than about 190° C., inclusive of all values in between and the end values of the range.

In one or more embodiments, which may be combined with other embodiments, the heat management subsystem is operated such that no heat transfer fluid flows through a hot heat transfer fluid reject line coupled to the hot heat transfer fluid storage vessel.

FIG. 6 is a schematic representation of an embodiment improved adiabatic compressed air energy storage (IA-CAES) system. Embodiment system 6000 has several configuration differences with system 5000 of FIG. 5, especially in the power transmission subsystem and the heat management subsystem.

In one or more embodiments, which may be combined with other embodiments, the power transmission subsystem further comprises a second power coupling directed to and coupled with a second heat source in the heat management subsystem. In FIG. 6, power transmission subsystem 6400 is shown with both a first power supply extension 6456 and a second power supply extension 6458 directed into the heat management subsystem 6500. First power supply extension 6456 couples to a first heat pump 6570, which is a second heat source, and second power supply extension 6458 couples to a second heat pump 6574, which is a second heat source, to be described further.

The system also comprises a heat management subsystem that is configured such that the high-temperature heat transfer fluid storage vessel is also fluidly coupled with a medium-temperature heat transfer fluid storage vessel, where the medium-temperature heat transfer fluid storage vessel is also positioned upstream of and coupled to the low-temperature heat transfer fluid storage vessel. In one or more embodiments, which may be combined with other embodiments, the heat management subsystem is configured such that the first portion of the heat transfer fluid flow directed towards the heat management subsystem from the air compression train is directed into the high-temperature heat transfer fluid storage vessel and the second portion of the heat transfer fluid flow is directed towards the medium-temperature heat transfer fluid storage vessel. The heat management subsystem 6000 has a first heat source, which is first heat transfer pump 6570, with a similar pump and conduit configuration as previously described in heat management subsystem 5000 of FIG. 5, except as shown in FIG. 6 where in system 6000 that the combined hot heat transfer fluid reject line 6522 is routed to the medium-temperature heat transfer fluid storage vessel 6564.

In one or more embodiments, which may be combined with other embodiments, the heat management subsystem includes a second heat source, where the second heat source is indirectly fluidly coupled to both the high-temperature heat transfer fluid storage vessel and the medium-temperature heat transfer fluid storage vessel. In one or more embodiments, which may be combined with other embodiments, the heat management subsystem is configured such that the medium-temperature heat transfer storage vessel produces a medium-temperature heat transfer fluid flow. In one or more embodiments, which may be combined with other embodiments, the medium-temperature heat transfer fluid flow is bifurcated into a first portion of medium-temperature heat transfer fluid flow that is directed towards the high-temperature heat transfer fluid storage vessel and a second portion of medium-temperature heat transfer fluid flow that is directed towards the low-temperature heat transfer fluid storage vessel. In one or more embodiments, which may be combined with other embodiments, the heat management subsystem is configured such that both the first and second portions of the medium-temperature heat transfer fluid flow are introduced into the second heat source, where the second heat source is configured to extract heat from the second portion of the medium-temperature heat transfer fluid flow and transfer the extracted heat into the first portion of the medium-temperature heat transfer fluid flow.

As seen in FIG. 6, medium heat transfer fluid supply line 6532 passes from medium-temperature heat transfer fluid storage vessel 6564, where it is then bifurcated into a first portion of heat transfer fluid flow that is conveyed through hot transfer main line 6534, which is directed towards the high-temperature heat transfer fluid storage vessel 6564, and a second portion of heat transfer fluid flow that is conveyed through cold transfer main line 6536, which is directed towards the low-temperature heat transfer fluid storage vessel 6562. The second heat pump 6574, which is a second heat source, is configured such that heat is transferred from the second portion of the heat transfer fluid in the cold transfer main line 6536, forming a reduced heat transfer fluid in the reduced heat transfer fluid reject line 6536′, and transferred into the first portion of the heat transfer fluid traversing the hot transfer main line 6534, forming an improved heat transfer fluid in the improved heat transfer fluid main line 6534′.

The improved heat transfer fluid in the improved heat transfer fluid main line 6534′ is coupled to the high-temperature heat transfer fluid storage vessel 6560 and further improves the quality of the heat transfer fluid in the high-temperature heat transfer fluid storage vessel 6560 by providing a second source for transferring heat indirectly into the high-temperature heat transfer fluid storage vessel 6560 (the other option being the previously-referenced improved hot supply main line 6516′). Excess fluid from the high-temperature heat transfer fluid storage vessel 6560 may be transferred and stored in the medium-temperature heat transfer fluid storage vessel 6564 while the heat from that fluid is maintained in the medium-temperature heat transfer fluid storage vessel.

Medium heat transfer fluid reject line 6528 originates at the medium-temperature heat transfer fluid storage vessel 6564 and passes an amount of medium heat transfer fluid towards the low-temperature heat transfer fluid storage vessel 6562. Medium heat transfer fluid reject line 6528 and the reduced heat transfer fluid reject line 6536′ merge to form a combined medium heat transfer fluid in the combined medium heat transfer fluid reject line 6538. Similar to as previously described, combined medium heat transfer fluid reject line 6538 and heat transfer fluid with the cool return line 6504 heat transfer fluid are combined, in excess heat exchanger inlet line 6512 and are then introduced into the excess heat exchanger 6580.

In one or more embodiments, which may be combined with other embodiments, the heat management subsystem is operated such that the medium-temperature heat transfer fluid storage vessel is maintained at a temperature in between that of the low-temperature heat transfer fluid storage vessel and the of the high-temperature heat transfer fluid storage vessel, such as in a range of greater than about 20° C. and less than 190° C., such as in a range of from greater than about 20° C., 25° ° C., 30° C., 35° C., 40° C., 45° C., and about 50° C. to about 55° C., 60° C., 65° C., 70° C., 75° C., 80° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., and less than about 190° C., inclusive of all values in between and the end values of the range.

In one or more embodiments, which may be combined with other embodiments, the heat management subsystem is operated such that no heat transfer fluid flows through a medium heat transfer fluid reject line coupled to the medium heat transfer fluid storage vessel.

FIG. 7 is a schematic representation of an embodiment improved adiabatic compressed air energy storage (IA-CAES) system. Embodiment system 7000 has several configuration differences with system 6000 of FIG. 6, especially in the power transmission subsystem and the heat management subsystem.

In one or more embodiments, which may be combined with other embodiments, the power transmission subsystem further comprises a third power coupling directed to and coupled with a third heat source in the heat management subsystem. In FIG. 7, power transmission subsystem 7400 is shown with a first power supply extension 7456, a second power supply extension 7458, and a third power supply extension 7460, directed into the heat management subsystem 7500. First and second heat pumps 7570, 7574, respectively, are similar to first and second heat pumps 6570, 6574, respectively, of system 6000. Third power supply extension 7460 couples to a third heat pump 7570, which is a heat source, to be described further.

In one or more embodiments, which may be combined with other embodiments, the heat management system includes a third heat source, where the third heat source is indirectly fluidly coupled to the medium-temperature heat transfer fluid storage vessel and is fluidly and thermally directly coupled to the low-temperature heat transfer fluid storage vessel. In one or more embodiments, which may be combined with other embodiments, the heat management subsystem is configured such that the low-temperature heat transfer storage vessel produces a low-temperature heat transfer fluid flow that is directed towards the medium-temperature heat transfer fluid storage vessel. In one or more embodiments, which may be combined with other embodiments, the heat management subsystem is configured such that the low-temperature heat transfer fluid flow is introduced into the third heat source, where the third heat source is configured to extract heat from the low-temperature heat transfer fluid storage vessel and transfer the extracted heat into the low-temperature heat transfer fluid flow. The heat management subsystem 7000 of FIG. 7 is similar in configuration to the heat management subsystem 6000 of FIG. 6, but with additional fluidic and thermal intra-relationships, to be described further.

As seen in FIG. 7, low heat transfer fluid supply line 7542 passes from low-temperature heat transfer fluid storage vessel 7562 and is directed towards the medium-temperature heat transfer fluid storage vessel 7564. The third heat pump 7576 is configured such that the third heat source is thermally and fluidly directly coupled to the low-temperature heat transfer fluid storage vessel 7576. The third heat pump 7576 is a heat transfer apparatus that is configured to draw low-temperature heat transfer fluid directly from the low-temperature heat transfer fluid storage vessel 7562 through heat pump draw line 7540. The drawn heat transfer fluid passes into third heat pump 7576, where heat is extracted, thereby reducing the temperature of the drawn heat transfer fluid, forming diminished heat transfer fluid. The diminished heat transfer fluid is returned to the low-temperature heat transfer fluid storage vessel 7576 through vessel return line 7540′, where it further reduces the quality (that is, reduces the temperature) of the heat exchange fluid in the low-temperature heat transfer fluid storage vessel 7576. The extracted heat is transferred into the low-temperature heat transfer fluid flow traversing towards the medium-temperature heat transfer fluid storage vessel 7562, producing an improved heat transfer fluid flow traversing medium-temperature heat transfer fluid storage vessel introduction line 7542′.

The improved heat transfer fluid from the low-temperature heat exchange fluid storage tank further improves the quality or creates makeup of the heat transfer fluid in the medium-temperature heat transfer fluid storage vessel 7564 by providing a second option for transferring heat indirectly into the medium-temperature heat transfer fluid storage vessel 7564 (the other option being the combined hot heat transfer fluid reject line 7522). In turn, this recovered heat may be transferred at least in part to the high-temperature heat transfer fluid storage vessel 7570 through portions of the heat management subsystem 7000 previously described.

### PROPHETIC EXAMPLES

The following prophetic examples are provided to demonstrate reasonably predicted operational behavior for a comparative example system similar to the prior art configuration given in FIG. 1 as system 1000 versus embodiment systems having similar configuration to systems 2000, 3000, 5000, 6000, and 7000, of FIGS. 2, 3, 5, 6, and 7, respectively, at similar operational conditions.

### Comparative Example 1

Comparative Example 1 demonstrates the following properties of system 1000 overall as well as certain properties of subsystems, units, and streams, at conditions provided for in Table 1.

TABLE 1
Comparative Example 1.
Comparative Example 1

| Subsystem, Stream, or Unit | Value | Units |
|---|---|---|
| Air compression train (1100) | — | — |
| Air feed conduit (1102) | | |
| Mass flow | 260 | kg/s (dry) |
| Pressure | 1 | atm |
| Humidity | 85 | % |
| Temperature | 26 | ° C. |
| Cooling heat transfer fluid header (1140) | | |
| Temperature (fluid inlet intercooler) | 30 | ° C. |
| Hot heat transfer fluid return header (1150) | | |
| Temperature | 175 | ° C. |
| Compressed air header (1104) | | |
| Temperature (air exit of intercooler) | 40 | ° C. |
| Power consumed, total | 159.3 | MW |
| Compressed air storage (1200) | | |
| Air storage facility (1260) | | |
| Temperature | 50.6 | ° C. |
| Pressure | 140 | bar (abs) |
| Air expansion train (1300) | | |
| Air exhaust conduit (1304) | | |
| Mass flow | 260 | kg/s (dry) |
| Temperature (in between preheate | 165 | ° C. |
| and expander units) | | |
| Heated heat transfer fluid header (1340) | | |
| Temperature | 175 | ° C. |
| Cool heat transfer fluid return header (1350) | 70 | ° C. |
| Power produced, total | 106.3 | MW |
| Heat Management Subsystem (1500) | | |
| Hot return line (1502) | | |
| Temperature | 175 | ° C. |
| Mass flow | 282 | kg/s |
| High-temperature heat transfer fluid | | |
| storage vessel 1560 | | |
| Temperature | 175 | ° C. |
| Hot heat transfer fluid feed line (1506) | | |
| Temperature | 175 | ° C. |
| Mass flow | 254 | kg/s |
| Percentage of mass flow | 90 | % |
| Hot heat transfer fluid reject line (1510) | | |
| Temperature | 175 | ° C. |
| Mass flow | 28 | kg/s |
| Percentage mass flow | 10 | % |
| Cool return line (1504) | | |
| Temperature | 70 | ° C. |
| Mass flow | 254 | kg/s |
| Excess heat exchanger (1580) | | |
| Heat rejected | 59 | MW |
| Introduction line (1514) | | |
| Temperature | 30 | ° C. |
| Low-temperature heat transfer fluid | | |
| storage vessel (1562) | | |
| Temperature | 30 | ° C. |
| Cool heat transfer fluid feed line (1508) | | |
| Temperature | 30 | ° C. |
| Mass flow | 282 | kg/s |
| Power diff erential (expansions vs. compression) | −53 | MW |

One of skill in the in art may appreciate that system 1000 is a net consumer of power as it requires more power to compress the ambient, humid air than it does to expand it. Despite a significant portion of the heat recovered from the air compression train into hot heat exchange fluid storage vessel is provided back to the air expansion train, there is still is an amount of heat rejection from excess heat exchanger to cool the heat transfer fluid coming from the expansion-side of the process before being used in the compression-side of the process. Reducing the amount of heat rejected into the atmosphere and simply being wasted is a benefit of the embodiment processes, as will be demonstrated.

### Example 1

Example 1 demonstrates the following properties of system 2000 overall as well as certain properties of subsystems, units, and streams, at conditions provided for in Table 2.

TABLE 2
Example 1.
Example 1

| Subsystem, Stream, or Unit | Value | Units |
|---|---|---|
| Air compression train (2100) | — | — |
| Air feed conduit (2102) | | |
| Mass flow | 260 | kg/s (dry) |
| Pressure | 1 | atm |
| Humidity | 85 | % |
| Temperature | 26 | ° C. |
| Cooling heat transfer fluid header (2140) | | |
| Temperature (fluid inlet intercooler) | 30 | ° C. |
| Hot heat transfer fluid return header (2150) | | |
| Temperature | 175 | ° C. |
| Compressed air header (2104) | | |
| Temperature (air exit of intercooler) | 40 | |
| Power consumed, total | 159.3 | MW |
| Compressed air storage (2200) | | |
| Air storage facility (2260) | | |
| Temperature | 50.6 | ° C. |
| Pressure | 140 | bar (abs) |
| Air expansion train (2300) | | |
| Air exhaust conduit (2304) | | |
| Mass flow | 260 | kg/s (dry) |
| Temperature (in between preheater and | 175 | ° C. |
| expander units) | | |
| Heated heat transfer fluid header (2340) | | |
| Temperature | 185 | ° C. |
| Cool heat transfer fluid return header (2350) | 76 | ° C. |
| Power produced, total | 108.9 | MW |
| Heat Management Subsystem (2500) | | |
| Hot return line (2502) | | |
| Temperature | 175 | ° C. |
| Mass flow | 282 | kg/s |
| Hot supply main line (2516) | | |
| Temperature | 175 | ° C. |
| Mass flow | 256 | kg/s |
| Percentage of mass flow | 90.8 | % |
| Hot return bypass line (2518) | | |
| Temperature | 175 | ° C. |
| Mass flow | 26 | kg/s |
| Percentage of mass flow | 9.2 | % |
| High-temperature heat transfer fluid | | |
| storage vessel (2560) | | |
| Temperature | 185 | ° C. |
| First heat pump (2570) | | |
| Power consumed, total | 2.7 | MW |
| Reduced temperature heat transfer | | |
| fluid reject line (2518′) | | |
| Temperature | 95 | ° C. |
| Hot heat transfer fluid feed line (2506) | | |
| Temperature | 185 | ° C. |
| Mass flow | 253 | kg/s |
| Percentage of mass flow | 98.83 | % |
| Hot heat transfer fluid reject line (2510) | | |
| Temperature | 185 | ° C. |
| Mass flow | 3 | kg/s |
| Percentage mass flow | 1.17 | % |
| Cool return line (2504) | | |
| Temperature | 76 | ° C. |
| Mass flow | 253 | kg/s |
| Excess heat exchanger (2580) | | |
| Heat rejected | 57.9 | MW |
| Introduction line (2514) | | |
| Temperature | 30 | ° C. |
| Low-temperature heat transfer fluid | | |
| storage vessel (2562) | | |
| Temperature | 30 | ° C. |
| Cool heat transfer fluid feed line (2508) | | |
| Temperature | 30 | ° C. |
| Mass flow | 282 | kg/s |
| Power differential (expansion vs. | −53.1 | MW |
| compression + heat management) | | |

In taking a closer look at the differences between Comparative Example 1 and Example 1, several things may be noted. First and foremost, the external power requirement for the system is almost exactly the same: 0.1 MW differential in favor of Comparative Example 1. Part of the reason for this is slightly more power generation by the air expansion train due to running at higher preheater heat transfer fluid temperature (185° C. vs. 175° C.) to offset the first heat pump power consumption. Despite the higher preheater operation temperature and higher cool return line temperature (70° C. vs. 76° C.), less heat is rejected into the atmosphere by excess heat exchanger (−1.1 MW). This is because more heat is retained in the high-temperature heat transfer fluid storage tank by use of the first heat pump to extract heat from the bypass flow. Less than 10% of the mass flow of the heat transfer fluid returned to the hot heat transfer fluid storage tank bypasses the tank and is used to extract heat from. Using the bypass and extracting heat from the bypass stream to improve the quality of the heat transfer fluid in the high-temperature heat transfer fluid storage tank instead of rejecting heat transfer fluid out of the bottom of the high-temperature heat transfer fluid storage tank and then using the excess heat cooler to reject the heat results in less wasted heat through the excess heat cooler, even when running at higher temperatures.

### Example 2

Example 2 demonstrates the following properties of system 3000 overall as well as certain properties of subsystems, units, and streams, at conditions provided for in Table 3.

TABLE 3
Example 2.
Example 2

| Subsystem, Stream, or Unit | Value | Units |
|---|---|---|
| Air compression train (3100) | — | — |
| Air feed conduit (3102) | | |
| Mass flow | 260 | kg/s (dry) |
| Pressure | 1 | atm |
| Humidity | 85 | % |
| Temperature | 26 | ° C. |
| Cooling heat transfer fluid header (3140) | | |
| Temperature (fluid inlet intercooler) | 30 | ° C. |
| Hot heat transfer fluid return header (3150) | | |
| Temperature | 175 | ° C. |
| Compressed air header (3104) | | |
| Temperature (air exit of intercooler) | 40 | ° C. |
| Power consumed, total | 159.3 | MW |
| Compressed air storage (3200) | | |
| Air storage facility (3260) | | |
| Temperature | 50.6 | ° C. |
| Pressure | 140 | bar (abs) |
| Air expansion train (3300) | | |
| Air exhaust conduit (3304) | | |
| Mass flow | 260 | kg/s (dry) |
| Temperature (in between preheater and | 175 | ° C. |
| expander units) | | |
| Heated heat transfer fluid header (3340) | | |
| Temperature | 185 | ° C. |
| Cool heat transfer fluid return header (3350) | 76 | ° C. |
| Power produced, total | 108.9 | MW |
| Heat Management Subsystem (3500) | | |
| Hot return line (3502) | | |
| Temperature | 175 | ° C. |
| Mass flow | 282 | kg/s |
| High-temperature heat transfer fluid | | |
| storage vessel (3560) | | |
| Temperature | 185 | ° C. |
| Electrical heater (3572) | | |
| Power consumed, total | 11.9 | MW |
| Hot heat transfer fluid feed line (3506) | | |
| Temperature | 185 | ° C. |
| Mass flow | 253 | kg/s |
| Percentage of mass flow | 89.7 | % |
| Hot heat transfer fluid reject line (3510) | | |
| Temperature | 185 | ° C. |
| Mass flow | 29 | kg/s |
| Percentage mass flow | 10.3 | % |
| Cool return line (3504) | | |
| Temperature | 76 | ° C. |
| Mass flow | 253 | kg/s |
| Excess heat exchanger (3580) | | |
| Heat rejected | 67.5 | MW |
| Introduction line (3514) | | |
| Temperature | 30 | ° C. |
| Low-temperature heat transfer fluid | | |
| storage vessel (3562) | | |
| Temperature | 30 | ° C. |
| Cool heat transfer fluid feed line (3508) | | |
| Temperature | 30 | ° C. |
| Mass flow | 282 | kg/s |
| Power differential (expansion vs. | −62.3 | MW |
| compression + heat management) | | |

In taking a closer look at the differences between Comparative Example 1 and Example 2, several things may be noted. The external power requirement for the system is significantly greater than Comparative Example 1: 9.3 MW. This is largely in part due to the electrical heater being utilized to directly improve the quality of the heat transfer fluid in the hot heat transfer fluid storage vessel. As with Example 1, a portion of the power consumption is offset by operating the air expansion train at a higher preheater temperature than the Comparative Example. The excess heat exchanger of Example 2 ends up rejecting 8.5 MW more heat into the environment than the excess heat exchanger of the Comparative Example.

### Example 3

Example 3 demonstrates the following properties of system 5000 overall as well as certain properties of subsystems, units, and streams, at conditions provided for in Table 4.

TABLE 4
Example 3.
Example 3

| Subsystem, Stream, or Unit | Value | Units |
|---|---|---|
| Air compression train (5100) | — | — |
| Air feed conduit (5102) | | |
| Mass flow | 260 | kg/s (dry) |
| Pressure | 1 | atm |
| Humidity | 85 | % |
| Temperature | 26 | ° C. |
| Cooling heat transfer fluid header (5140) | | |
| Temperature (fluid inlet intercooler) | 30 | ° C. |
| Hot heat transfer fluid return header (5150) | | |
| Temperature | 175 | ° C. |
| Compressed air header (5104) | | |
| Temperature (air exit of intercooler) | 40 | ° C. |
| Power consumed, total | 159.3 | MW |
| Compressed air storage (5200) | | |
| Air storage facility (5260) | | |
| Temperature | 50.6 | ° C. |
| Pressure | 140 | bar (abs) |
| Air expansion train (5300) | | |
| Air exhaust conduit (5304) | | |
| Mass flow | 260 | kg/s (dry) |
| Temperature (in between preheater and | 175 | ° C. |
| expander units) | | |
| Heated heat transfer fluid header (5340) | | |
| Temperature | 185 | ° C. |
| Cool heat transfer fluid return header (5350) | 76 | ° C. |
| Power produced, total | 108.9 | MW |
| Heat Management Subsystem (5500) | | |
| Hot return line (5502) | | |
| Temperature | 175 | ° C. |
| Mass flow | 282 | kg/s |
| Hot supply main line (5516) | | |
| Temperature | 175 | ° C. |
| Mass flow | 256 | kg/s |
| Percentage of mass flow | 90.8 | % |
| Hot return bypass line (5518) | | |
| Temperature | 175 | ° C. |
| Mass flow | 26 | kg/s |
| Percentage of mass flow | 9.2 | % |
| First heat pump (5570) | | |
| Power consumed, total | 2.7 | MW |
| Improved supply main line (5516′) | | |
| Temperature | 185 | ° C. |
| Mass flow | 256 | kg/s |
| Reduced temperature heat transfer fluid | | |
| reject line (5518′) | | |
| Temperature | 95 | ° C. |
| Mass flow | 26 | kg/s |
| High-temperature heat transfer fluid | | |
| storage vessel (5560) | | |
| Temperature | 185 | ° C. |
| Hot heat transfer fluid feed line (5506) | | |
| Temperature | 185 | ° C. |
| Mass flow | 253 | kg/s |
| Percentage of mass flow | 98.83 | % |
| Hot heat transfer fluid reject line (5510) | | |
| Temperature | 185 | ° C. |
| Mass flow | 3 | kg/s |
| Percentage mass flow | 1.17 | % |
| Cool return line (5504) | | |
| Temperature | 76 | ° C. |
| Mass flow | 253 | kg/s |
| Excess heat exchanger (5580) | | |
| Heat rejected | 57.9 | MW |
| Introduction line (5514) | | |
| Temperature | 30 | ° C. |
| Low-temperature heat transfer fluid storage | | |
| vessel (5562) | | |
| Temperature | 30 | ° C. |
| Cool heat transfer fluid feed line (5508) | | |
| Temperature | 30 | ° C. |
| Mass flow | 282 | kg/s |
| Power differential (expansion vs. | −53.1 | MW |
| compression + heat management) | | |

In taking a closer look at the differences between Comparative Example 1, Example 1, and Example 3, one may note that the results of Examples 1 and 3 are essentially the same with a slightly different fluid handing configurations. Example 1 of system 1000 directly transfers heat from a bypass stream fluid into the storage vessel through the first heat pump, whereas Example 3 of system 3000 indirectly transfers the same heat recovered into a stream to be introduced into the storage vessel.

### Example 4

Example 4 demonstrates the following properties of system 6000 overall as well as certain properties of subsystems, units, and streams, at conditions provided for in Table 5.

TABLE 5
Example 4.
Example 4

| Subsystem, Stream, or Unit | Value | Units |
|---|---|---|
| Air compression train (6100) | — | — |
| Air feed conduit (6102) | | |
| Mass flow | 260 | kg/s (dry) |
| Pressure | 1 | atm |
| Humidity | 35 | % |
| Temperature | 26 | ° C. |
| Cooling heat transfer fluid header (6140) | | |
| Temperature (fluid inlet intercooler) | 30 | ° C. |
| Hot heat transfer fluid return header (6150) | | |
| Temperature | 175 | ° C. |
| Compressed air header (6104) | | |
| Temperature (air exit of intercooler) | 40 | ° C. |
| Power consumed, total | 158.3 | MW |
| Compressed air storage (6200) | | |
| Air storage facility (6260) | | |
| Temperature | 50.6 | ° C. |
| Pressure | 140 | bar (abs) |
| Air expansion train (6300) | | |
| Air exhaust conduit (6304) | | |
| Mass flow | 260 | kg/s (dry) |
| Temperature (in between preheater and | 175 | ° C. |
| expander units) | | |
| Heated heat transfer fluid header (6340) | | |
| Temperature | 185 | ° C. |
| Cool heat transfer fluid return header (6350) | 76 | ° C. |
| Power produced, total | 108.9 | MW |
| Heat Management Subsystem (6500) | | |
| Hot return line (6502) | | |
| Temperature | 175 | ° C. |
| Mass flow | 268 | kg/s |
| Hot supply main line (6516) | | |
| Temperature | 175 | ° C. |
| Mass flow | 245 | kg/s |
| Percentage of mass flow | 91.4 | % |
| Hot return bypass line (6518) | | |
| Temperature | 175 | ° C. |
| Mass flow | 23 | kg/s |
| Percentage of mass flow | 8.6 | % |
| First heat pump (6570) | | |
| Power consumed, total | 2.4 | MW |
| Improved supply main line (6516′) | | |
| Temperature | 185 | ° C. |
| Mass flow | 245 | kg/s |
| Reduced temperature heat transfer | | |
| fluid reject line (6518′) | | |
| Temperature | 95 | ° C. |
| Mass flow | 23 | kg/s |
| High-temperature heat transfer fluid | | |
| storage vessel (6560) | | |
| Temperature | 185 | ° C. |
| Hot heat transfer fluid feed line (6506) | | |
| Temperature | 185 | ° C. |
| Mass flow | 253 | kg/s |
| Percentage of mass flow | 100 | % |
| Hot heat transfer fluid reject line (6510) | | |
| Temperature | 185 | ° C. |
| Mass flow | 0 | kg/s |
| Percentage mass flow | 0 | % |
| Combined hot heat transfer fluid reject line (6522) | | |
| Temperature | 95 | ° C. |
| Mass flow | 23 | kg/s |
| Medium-temperature heat transfer fluid | | |
| storage vessel (6564) | | |
| Temperature | 95 | ° C. |
| Medium heat transfer fluid supply line (6532) | | |
| Temperature | 95 | ° C. |
| Mass flow | 23 | kg/s |
| Hot transfer main line (6534) | | |
| Temperature | 95 | ° C. |
| Mass flow | 8 | kg/s |
| Percentage of mass flow | 34.8 | % |
| Cold transfer main line (6536) | | |
| Temperature | 95 | ° C. |
| Mass flow | 15 | kg/s |
| Percentage of mass flow | 65.2 | % |
| Second heat pump (6574) | | |
| Power consumed, total | 2.4 | MW |
| Improved heat transfer fluid main line (6534′) | | |
| Temperature | 185 | ° C. |
| Mass flow | 8 | kg/s |
| Reduced heat transfer fluid reject line (6536′) | | |
| Temperature | 60 | ° C. |
| Mass flow | 15 | kg/s |
| Medium heat transfer fluid reject line (6528) | | |
| Temperature | 95 | ° C. |
| Mass flow | 0 | kg/s |
| Cool return line (6504) | | |
| Temperature | 76 | ° C. |
| Mass flow | 253 | kg/s |
| Excess heat exchanger (6580) | | |
| Heat rejected | 50.1 | MW |
| Introduction line (6514) | | |
| Temperature | 30 | ° C. |
| Low-temperature heat transfer fluid | | |
| storage vessel (6562) | | |
| Temperature | 30 | ° C. |
| Cool heat transfer fluid feed line (6508) | | |
| Temperature | 30 | ° C. |
| Mass flow | 268 | kg/s |
| Power differential (expansion vs. | −54.2 | MW |
| compression + heat management) | | |

In taking a closer look at the differences between Comparative Example 1, Example 3, and Example 4, one may note that the results of Example 4, in summary, has dramatically reduced heat rejection from the excess heat exchanger of system 6000 versus the excess heat exchanger of system 1000 (−8.9 MW). In this configuration and operation, neither the hot nor the medium heat transfer fluid reject lines are utilized to downgrade heat transfer fluid without first recapturing heat. Much of the heat from the system is retained in medium-temperature heat exchange fluid storage vessel, which is shown transferring heat into the hot-temperature heat exchange fluid storage vessel. Because not all the heat is necessarily retained in the hot-temperature heat exchange fluid storage vessel in system 6000, there is also a reduction in the mass flow of heat exchange fluid to and from the air compression train 6100 over Example 3 (about 5% less). This leads to reduced power consumption for the air compression train to offset providing power to the second heat pump, although part of this is due to a reduction in the assumed humidity of the intake air (85% versus 35%). The overall power consumption of Example 4 is up slightly (about 2.2% or 1.2 MW) over Comparative Example 1.

### Example 5

Example 5 demonstrates the following properties of system 7000 overall as well as certain properties of subsystems, units, and streams, at conditions provided for in Table 6.

Example 5

| Subsystem, Stream, or Unit | Value | Units |
|---|---|---|
| Air compression train (7100) | — | — |
| Air feed conduit (7102) | | |
| Mass flow | 260 | kg/s (dry) |
| Pressure | 1 | atm |
| Humidity | 10 | % |
| Temperature | 26 | ° C. |
| Cooling heat transfer fluid header (7140) | | |
| Temperature (fluid inlet intercooler) | 30 | ° C. |
| Hot heat transfer fluid return header (7150) | | |
| Temperature | 176 | ° C. |
| Compressed air header (7104) | | |
| Temperature (air exit of intercooler) | 40 | ° C. |
| Power consumed, total | 157.5 | MW |
| Compressed air storage (7200) | | |
| Air storage facility (7260) | | |
| Temperature | 50.6 | ° C. |
| Pressure | 140 | bar (abs) |
| Air expansion train (7300) | | |
| Air exhaust conduit (7304) | | |
| Mass flow | 260 | kg/s (dry) |
| Temperature (in between preheater and | 175 | ° C. |
| expander units) | | |
| Heated heat transfer fluid header (7340) | | |
| Temperature | 185 | ° C. |
| Cool heat transfer fluid return header (7350) | 76 | ° C. |
| Power produced, total | 108.9 | MW |
| Heat Management Subsystem (7500) | | |
| Hot return line (7502) | | |
| Temperature | 176 | ° C. |
| Mass flow | 261 | kg/s |
| Hot supply main line (7516) | | |
| Temperature | 176 | ° C. |
| Mass flow | 239 | kg/s |
| Percentage of mass flow | 91.57 | % |
| Hot return bypass line (7518) | | |
| Temperature | 175 | ° C. |
| Mass flow | 22 | kg/s |
| Percentage of mass flow | 8.43 | % |
| First heat pump (7570) | | |
| Power consumed, total | 2.4 | MW |
| Improved supply main line (7516′) | | |
| Temperature | 185 | ° C. |
| Mass flow | 239 | kg/s |
| Reduced temperature heat transfer | | |
| fluid reject line (7518′) | | |
| Temperature | 95 | ° C. |
| Mass flow | 22 | kg/s |
| High-temperature heat transfer fluid | | |
| storage vessel (7560) | | |
| Temperature | 185 | ° C. |
| Hot heat transfer fluid feed line (7506) | | |
| Temperature | 185 | ° C. |
| Mass flow | 253 | kg/s |
| Percentage of mass flow | 100 | % |
| Hot heat transfer fluid reject line (7510) | | |
| Temperature | 185 | ° C. |
| Mass flow | 0 | kg/s |
| Percentage mass flow | 0 | % |
| Combined hot heat transfer fluid reject line (7522) | | |
| Temperature | 95 | ° C. |
| Mass flow | 22 | kg/s |
| Medium-temperature heat transfer fluid | | |
| storage vessel (7564) | | |
| Temperature | 95 | ° C. |
| Medium heat transfer fluid supply line (7532) | | |
| Temperature | 95 | ° C. |
| Mass flow | 39.3 | kg/s |
| Hot transfer main line (7534) | | |
| Temperature | 95 | ° C. |
| Mass flow | 14 | kg/s |
| Percentage of mass flow | 35.62 | % |
| Cold transfer main line (7536) | | |
| Temperature | 95 | ° C. |
| Mass flow | 25.3 | kg/s |
| Percentage of mass flow | 64.38 | % |
| Second heat pump (7574) | | |
| Power consumed, total | 1.64 | MW |
| Improved heat transfer fluid main line (7534′) | | |
| Temperature | 185 | ° C. |
| Mass flow | 14 | kg/s |
| Reduced heat transfer fluid reject line (7536′) | | |
| Temperature | 60 | ° C. |
| Mass flow | 25.3 | kg/s |
| Medium heat transfer fluid reject line (7528) | | |
| Temperature | 95 | ° C. |
| Mass flow | 0 | kg/s |
| Cool return line (7504) | | |
| Temperature | 76 | ° C. |
| Mass flow | 253 | kg/s |
| Excess heat exchanger (7580) | | |
| Heat rejected | 48.2 | MW |
| Introduction line (7514) | | |
| Temperature | 30 | ° C. |
| Low-temperature heat transfer fluid | | |
| storage vessel (7562) | | |
| Temperature | 30 | ° C. |
| Third heat pump (7576) | | |
| Power consumed, total | 1.3 | MW |
| Heat pump draw line (7540) | | |
| Temperature | 30 | ° C. |
| Vessel return line (7540') | | |
| Temperature | 20 | ° C. |
| Low heat transfer fluid supply line (7542) | | |
| Temperature | 30 | ° C. |
| Mass flow | 17.3 | kg/s |
| Medium-temperature heat transfer fluid | | |
| storage vessel introduction line (7542') | | |
| Temperature | 95 | ° C. |
| Mass flow | 17.3 | kg/s |
| Cool heat transfer fluid feed line (7508) | | |
| Temperature | 30 | ° C. |
| Mass flow | 261 | kg/s |
| Power differential (expansion vs. | −53.94 | MW |
| compression + heat management) | | |

In taking a closer look at the differences between Comparative Example 1 and Examples 3-5, one may note that the results of Example 5, in summary, is dramatically reduced heat rejection from the excess heat exchanger of system 7000 versus the excess heat exchanger of system 1000 (−10.8 MW). As with Example 4, in this configuration and operation neither the hot nor the medium heat transfer fluid reject lines are utilized to downgrade heat transfer fluid without first recapturing heat. Much of the heat from the system is retained in medium-temperature heat exchange fluid storage vessel, which is shown transferring heat into the hot-temperature heat exchange fluid storage vessel. The addition of the third heat pump drawing energy from the low-temperature heat exchange fluid storage vessel permits the excess heat exchanger to reject less heat as heat will be removed from the low-temperature heat exchange fluid storage vessel and introduced into the medium-temperature heat exchange fluid storage vessel. This permits heat to be chained from the cold- to the medium- to the hot-temperature storage vessels, permitting more than one chance to recover heat from any one stream all throughout the system 7000. The overall power consumption of Example 5 is improved over that of Example 4 and is about 1.8% greater than Comparative Example 1.

Overall, the embodiment examples show that a significant amount of latent heat that would have been wasted into the environment is recovered and utilized to provide energy balance to the system.

While the various steps in an embodiment method or process are presented and described sequentially, one of ordinary skill in the art will appreciate that some or all of the steps may be executed in different order, may be combined or omitted, and some or all of the steps may be executed in parallel. The steps may be performed actively or passively. The method or process may be repeated or expanded to support multiple components or multiple users within a field environment. Accordingly, the scope should not be considered limited to the specific arrangement of steps shown in a flowchart or diagram.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise. Within a claim, reference to an element in the singular is not intended to mean “one and only one” unless specifically so stated, but rather “one or more.” Unless specifically stated otherwise, the term “some” refers to one or more.

Embodiments of the present disclosure may suitably “comprise”, “consist” or “consist essentially of” the limiting features disclosed, and may be practiced in the absence of a limiting feature not disclosed. As used here and in the appended claims, the words “comprise,” “has,” and “include” and all grammatical variations thereof are each intended to have an open, non-limiting meaning that does not exclude additional elements or steps.

When the word “approximately” or “about” are used, this term may mean that there can be a variance in value of up to±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

As used, terms such as “first” and “second” are arbitrarily assigned and are merely intended to differentiate between two or more components of a system, an apparatus, or a composition. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is contemplated under the scope of the various embodiments described.

Although only a few example embodiments have been described in detail, those skilled in the art will readily appreciate that many modifications are possible in the example embodiments without materially departing from the disclosed scope as described. Accordingly, all such modifications are intended to be included within the scope of this disclosure as defined in the following claims. In the claims, means-plus-function clauses are intended to cover the structures described as performing the recited function and not only structural equivalents, but also equivalent structures. For example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f), for any limitations of any of the claims, except for those in which the claim expressly uses the words ‘means for’ together with an associated function.

The following claims are not intended to be limited to the embodiments provided but rather are to be accorded the full scope consistent with the language of the claims.

What is claimed is:

1. A system, comprising:
an air compression train configured to receive an atmospheric air feed flow and a first amount power and to produce a cooled, compressed air;
a compressed air storage coupled to the air compression train and configured to receive the cooled, compressed air, to maintain the cooled, compressed air as a stored, compressed air for an indefinite period, and to produce the stored, compressed air;
an air expansion train coupled to the compressed air storage and configured to receive the stored, compressed air and to produce an exhausted, decompressed air flow and a second amount of power, where the first amount of power is greater than or equal to the second amount of power;
a heat management subsystem that is coupled to the air compression train and is configured to receive a heated heat transfer fluid flow from the air compression train and to provide a low-temperature heat transfer fluid flow to the air compression train from a low-temperature heat transfer fluid storage vessel, that is coupled to the air expansion train and is configured to receive a cooled heat transfer fluid flow from the air expansion train and to provide a high-temperature heat transfer fluid flow to the air expansion train from a high-temperature heat transfer fluid storage vessel, that is configured such that the high-temperature heat transfer fluid storage vessel is positioned upstream of and coupled to the low-temperature heat transfer fluid storage vessel, and that is configured such that a first heat source is coupled to the high-temperature heat transfer fluid storage vessel; and
a power transmission subsystem coupled to the air compression train, the heat management subsystem, and the air expansion train, and is configured to provide power to the air compression train and the heat management subsystem and to receive power from the air expansion train, where a first power coupling directed to the heat management subsystem couples to the first heat source.

2. The system of claim 1, where the power transmission subsystem is further configured to receive and provide power as selected from the group comprising electrically, pneumatically, hydraulically, mechanically, and combinations thereof.

3. The system of claim 1, where the heat management subsystem is further configured such that the first heat source is directly coupled to the high-temperature heat transfer fluid storage vessel and indirectly coupled to the low-temperature heat transfer fluid storage vessel.

4. The system of claim 3, where the heat management subsystem is further configured such that the heated heat transfer fluid flow from the air compression train is bifurcated into a first portion and a second portion, where both the first portion and the second portion of the heat transfer fluid flow directed towards the heat management subsystem from the air compression train are introduced into the first heat source, where the first portion of the heated heat transfer fluid flow from the air compression train is directed into the high-temperature heat transfer fluid storage vessel and the second portion of the heat transfer fluid directed towards the heat management subsystem from the air compression train is directed into the low-temperature heat transfer fluid storage vessel, and where the first heat source is configured to extract heat from the second portion of heated heat transfer fluid flow from the air compression train and transfer the extracted heat directly into the high-temperature heat transfer fluid storage vessel.

5. The system of claim 1, where the heat management subsystem is further configured such that the first heat source is an electrical heater that is directly coupled to the high-temperature heat transfer fluid storage vessel.

6. The system of claim 1, where the heat management subsystem is further configured such that the first heat source is directly coupled to both the high-temperature heat transfer fluid storage vessel and the low-temperature heat transfer fluid storage vessel.

7. The system of claim 1, where the heat management subsystem is further configured such that the first heat source is indirectly coupled to both the high-temperature heat transfer fluid storage vessel and the low-temperature heat transfer fluid storage vessel.

8. The system of claim 7, where the heat management subsystem is further configured such that the heated heat transfer fluid flow from the air compression train is bifurcated into a first portion and a second portion, where both the first portion and the second portion of the heat transfer fluid flow directed towards the heat management subsystem from the air compression train are introduced into the first heat source, where the first portion of the heated heat transfer fluid flow from the air compression train is directed into the high-temperature heat transfer fluid storage vessel and the second portion of the heat transfer fluid directed towards the heat management subsystem from the air compression train is directed into the low-temperature heat transfer fluid storage vessel, and where the first heat source is configured to extract heat from the second portion of heated heat transfer fluid flow from the air compression train and transfer the extracted heat into the first portion of heated heat transfer fluid flow from the air compression train.

9. The system of claim 7, where the heat management subsystem further comprises both a second heat source and a medium-temperature heat transfer fluid storage vessel, where the heat management subsystem is configured such that the second heat source is indirectly coupled to both the high-temperature heat transfer fluid storage vessel and a medium-temperature heat transfer fluid storage vessel and such that the high-temperature heat transfer fluid storage vessel is positioned upstream of and coupled to a medium-temperature heat transfer fluid storage vessel, and such that the medium-temperature heat transfer fluid storage vessel is positioned upstream of and coupled to the low-temperature heat transfer fluid storage vessel and where the power transmission subsystem further comprises a second power coupling that is directed to and couples with the second heat source in the heat management subsystem.

10. The system of claim 9, where the heat management subsystem is further configured such that the heated heat transfer fluid flow from the air compression train is bifurcated into a first portion and a second portion, where both the first portion and the second portion of the heat transfer fluid flow directed towards the heat management subsystem from the air compression train are introduced into the first heat source, where the first portion of the heated heat transfer fluid flow from the air compression train is directed into the high-temperature heat transfer fluid storage vessel and the second portion of the heat transfer fluid directed towards the heat management subsystem from the air compression train is directed into a medium-temperature heat transfer fluid storage vessel, where the medium-temperature heat transfer storage vessel produces a medium-temperature heat transfer fluid flow, where the medium-temperature heat transfer fluid flow is bifurcated into a first portion of medium-temperature heat transfer fluid flow that is directed towards the high-temperature heat transfer fluid storage vessel and a second portion of medium-temperature heat transfer fluid flow that is directed towards the low-temperature heat transfer fluid storage vessel, where both the first and second portions of the medium-temperature heat transfer fluid flow are introduced into the second heat source, and where the second heat source is configured to extract heat from the second portion of the medium-temperature heat transfer fluid flow and transfer the extracted heat into the first portion of the medium-temperature heat transfer fluid flow.

11. The system of claim 10, where the heat management subsystem further comprises a third heat source, where the heat management subsystem is configured such that the third heat source is directly coupled to the low-temperature heat transfer fluid storage vessel and is indirectly coupled to the medium-temperature heat transfer fluid storage vessel, and where the power transmission subsystem further comprises a third power coupling directed to and coupled with a third heat source in the heat management subsystem.

12. The system of claim 11, where the heat management subsystem is further configured such that the low-temperature heat transfer storage vessel produces a low-temperature heat transfer fluid flow that is directed towards the medium-temperature heat transfer fluid storage vessel and is introduced into the third heat source, and where the third heat source is configured to extract heat from the low-temperature heat transfer fluid storage vessel and transfer the extracted heat into the low-temperature heat transfer fluid flow.
